(19) United States
(12) Patent Application Publication
(10) Pub. No.: US 2011/0090509 A1
(43) Pub. Date: Apr. 21, 2011

(54) SPECTRAL OPTICAL COHERENCE TOMOGRAPHY APPARATUS WITH ATTACHMENT

(75) Inventors: Grzegorz Bednarczyk, Zawiercie (PL); Grzegorz Slusarczyk, Chorzow (PL); Pawel Wojdas, Zawiercie (PL)

(73) Assignee: OPTOPOLTechnology Spólka Akcyjna, Zawiercie (PL)

(21) Appl. No.: 12/934,067

(22) PCT Filed: Mar. 23, 2009
(86) PCT No.: PCT/IB2009/005074

§ 371 Date: Dec. 15, 2010

(30) Foreign Application Priority Data
Mar. 25, 2008 (PL) P-384779

(51) Int. Cl. G01B 9/02

(52) U.S. Cl. 356/479

(57) ABSTRACT

In the apparatus for examination of objects by means of optical tomography with the attachment comprising the device generating the light beam, the device splitting the light beam into at least one reference beam and at least one object beam directed through the lens to the examined object, the device generating the resultant beam from at least one reference beam and at least one object beam scattered by the object and returning from the object through the lens, the device for spectral analysis of the resultant beam and the attachment being an additional optical system (454) located between the lens of the SOCT device and the examined object.

The present invention relates to an apparatus for examination of objects by means of optical tomography, an apparatus for examination of objects by means of optical tomography with an attachment and method for examination of objects by means of optical tomography.

Among the apparatuses for objects imaging there are optical tomography apparatuses for objects imaging; optical tomography is one of the techniques for imaging objects and their structure, which is based on an analysis of a signal created from an interference between light reference beam and a light object beam, which is back-scattered by the object. Apparatuses for object imaging and/or object imaging methods using optical tomography are known in numerous variants, and many of them are equipped with additional devices. For example, from international patent application no. WO 2007/148310 “Apparatus for optical frequency domain tomography with adjusting system, adjusting system of apparatus for optical frequency domain tomography and method for adjusting apparatus for optical frequency domain tomography” there is known an apparatus for spectral optical tomography with an adjusting system. Examination of an object is based on an analysis of a resultant beam, created from an interference of a reference light beam and an object light beam, which is scattered by the object, partially reflected and then returns to the object. The resultant beam is directed onto a dispersion device, for example a diffraction grate, and then registered by a detection device or a spectrum recorder, for example a matrix of photosensitive elements used in a linear CCD camera. The signal generated by the recorder, usually in the form of a digital signal is transmitted to a computation unit, and information about the axial structure of the examined object is obtained as a result of numerical calculations in the computation unit, for example by means of a PC. In order to make object imaging more accurate, the apparatus for spectral optical tomography from the above-mentioned publication was equipped with an automatically controlled adjusting device causing a relative displacement of at least one photosensitive element of the detection system and the resultant beam spectrum image, until the spectrum image is displayed on the elements of the photosensitive detection system in the optimum way.

The idea of the invention is that in the apparatus for examining objects by means of optical tomography (SOCT device) with an attachment, comprising a device generating a light beam, a means for splitting the light beam into at least one reference beam and one object beam directed by the lens towards the examined object, a device generating a resultant beam from at least one reference beam and at least one object beam scattered onto the object and then returning through the lens, a device for spectral analysis of the resultant beam, and an attachment being an additional optical system located between the lens of the SOCT device and the examined object.

Favorably, the lens of the SOCT device is provided with an external focus for the object beam, where, in the period when the object is examined from the outside, the lens of an additional optical system is placed or the first lens of an additional optical system comprising more lenses, and in the period of examining the rear section of the object, the lens of the SOCT device has the external focus for the object beam in the pupil area.

An additional optical system may be put inside the attachment fixed to the lens of the SOCT device or in the attachment mounted onto the lens of the SOCT device, provided with a cylindrical element mounted on the lens of the SOCT device located opposite the attachment relative to the additional optical system.

Favorably, the attachment is equipped with at least one adjusting and/or mounting system which prevents displacement of the additional optical system relative to the lens of the SOCT device.

Favorably, the adjusting and/or mounting system is equipped with a flange that connects the cylindrical element and the casing inside which the additional optical system and/or at least one vertical mounting element and/or horizontal mounting element are placed, enabling movement of the additional optical system on the vertical plane and/or along the axis of the attachment and/or having at least one screw screwed into the cylindrical element, which when in contact with the lens enables movement of the additional optical system on the plane perpendicular to the axis of the attachment.

The cylindrical element can be provided with the threaded pipe, connecting the casing in the form of a sleeve, inside which the additional optical system is placed, or it can be provided with a threaded hole connecting the casing in the form of the sleeve with the external thread, inside which the additional optical system is placed.

Favorably, the additional optical system is a single lens or an assembly of lenses or a single lens from the assembly of lenses with different focal lengths.

Inside the cylindrical element, the elastic and deformable cylindrical insert can be placed, or the cylindrical element can be provided with the notch over the entire thickness of the cylindrical element's jacket.

The idea of the invention is also an attachment for the apparatus for examination of objects by means of optical tomography, characterized in that it has the form of the attachment mountable on the lens of the SOCT device, with a cylindrical element mountable on the lens of the SOCT device and the additional optical system located opposite the attachment relative to the cylindrical element.

Moreover, the idea of the invention is that in the method for examination of objects by means of the device for examination of objects using optical tomography with the attachment, comprising the device generating the light beam, the device splitting the light beam into at least one reference beam and at least one object beam directed through the lens onto the examined object, the device generating the resultant beam from at least one reference beam and at least one object beam scattered on the object and returning through the lens, the device for spectral analysis of the resultant beam and the attachment; for the period of examining the object from the outside by means of the SOCT device, the attachment is mounted onto the lens of the SOCT device, where the lens of the additional optical system or the first lens of the additional optical system comprising more than a single lens, is placed on the external focus of the lens of the SOCT device, and in the period of examining the back section of the object, the attachment is removed from the lens of the SOCT device.

Currently known optical devices do not enable comprehensive examination of transparent and semi-transparent objects, such as for example the eye.

The invention will be shown in embodiments in the drawing, where:

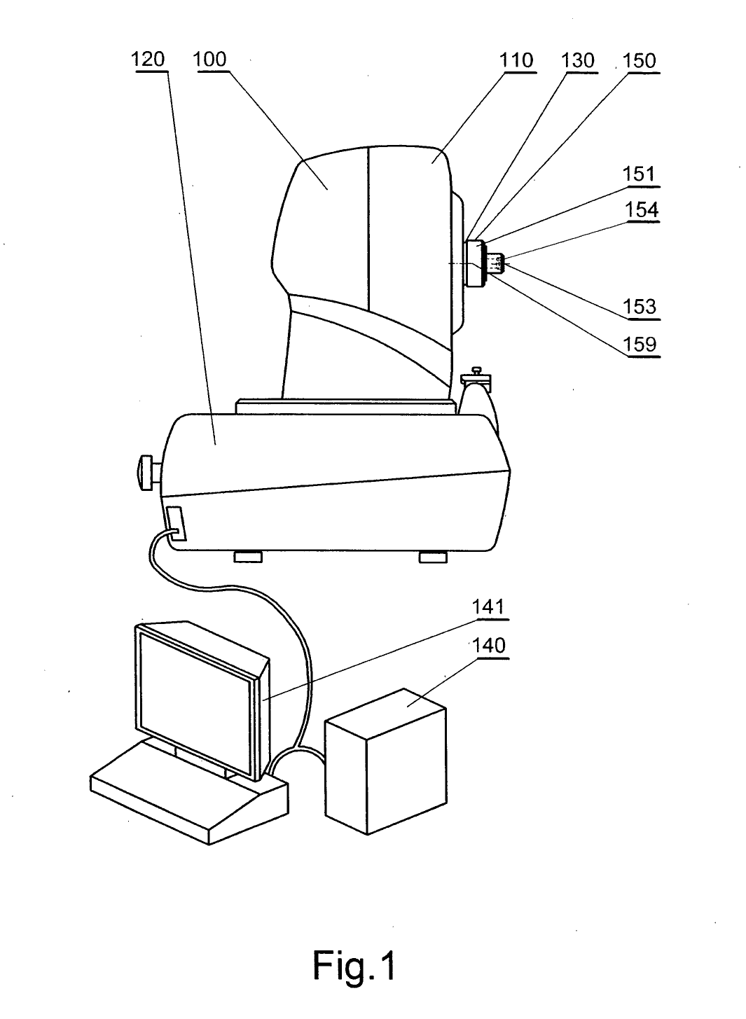

FIG. 1 shows the side view of the device for objects imaging by means of spectral optical tomography with an attachment mounted on the lens of the device;

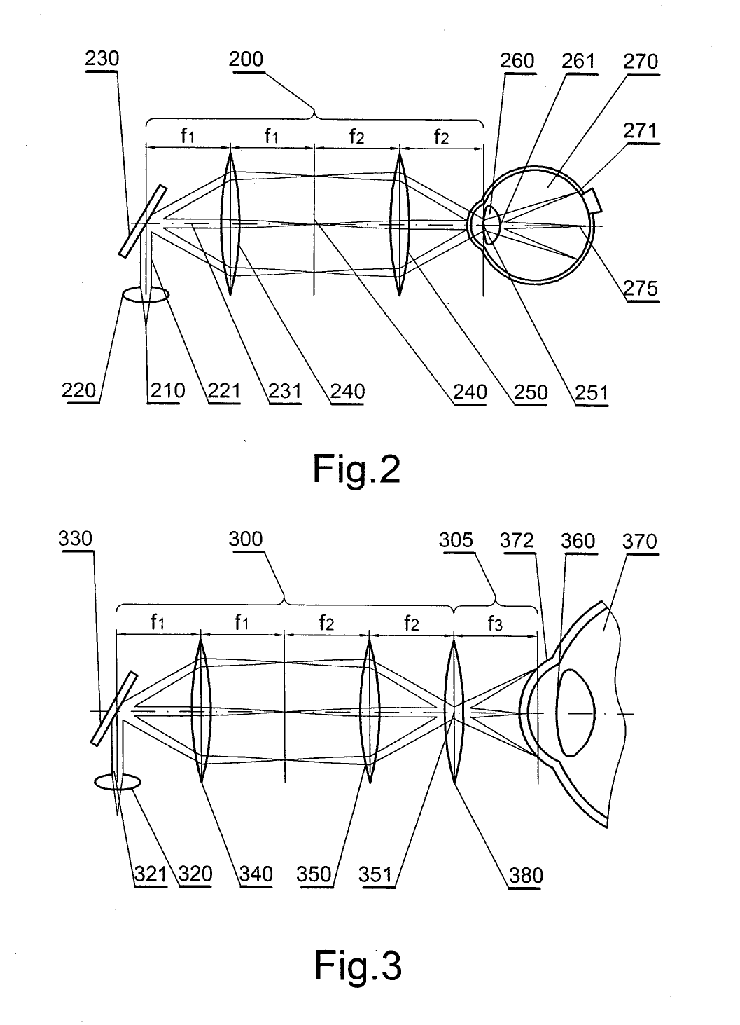

FIG. 2 shows the schematic view of the light beam route while scanning the back section of the object;

FIG. 3 shows the schematic view of the light beam route while scanning the front section of the object;

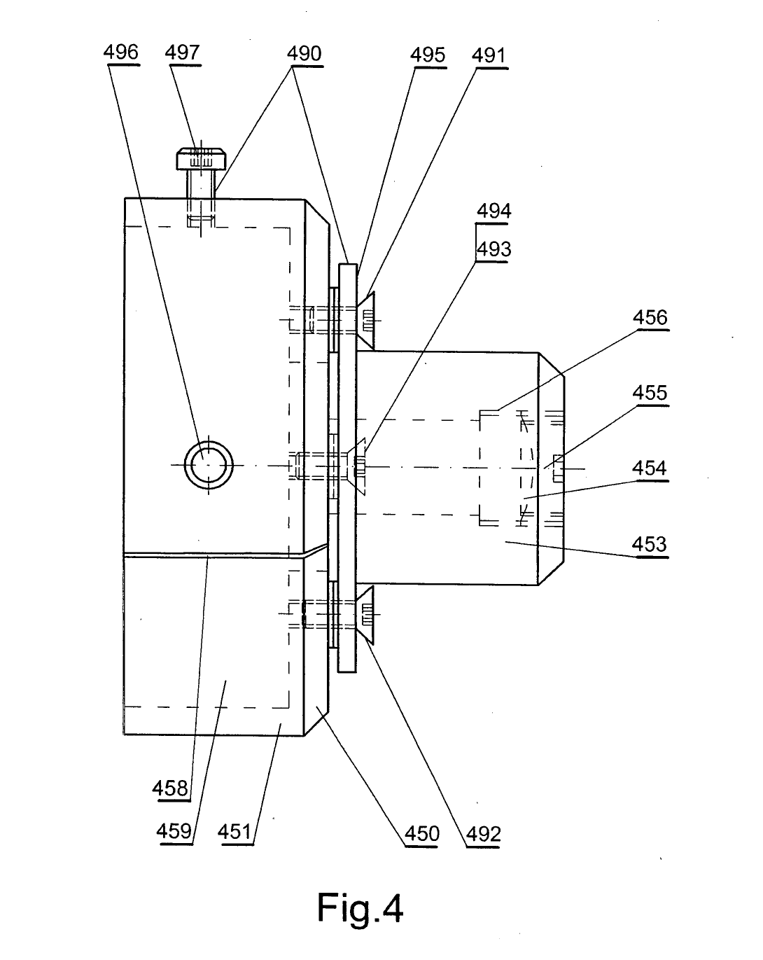

FIG. 4 shows the side view of one of the attachment variants;

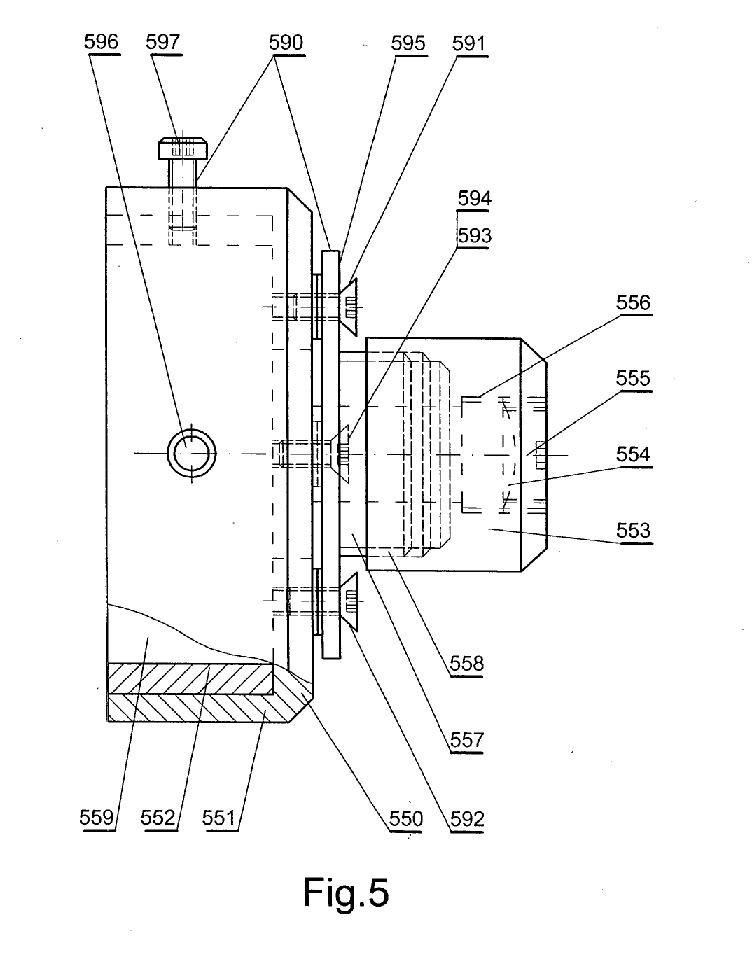

FIG. 5 shows the side view of another attachment variant.

The device for examination of objects by means of spectral optical tomography, abbreviated as the SOCT device, with the attachment fixed to the lens of the SOCT device, including the attachment mounted on the lens of the SOCT device, for which the solution according to the invention can be adapted, comprises multiple subassemblies, however, in the drawings and in the description the SOCT device has been presented in a marginal way, and emphasis has been put on the attachment, which is not part of the existing assemblies for examination of objects by means of spectral optical tomography. The elements performing the same functions are marked in all the figures with the same numerals or with the numerals, where only the first digit is different as assigned to a specific figure.

In the simplest embodiment, the SOCT device 100 with the upper part 110 and the base 120 comprising the power supply and controlling systems, comprises the light source generating the light beam which is split into two arms by the beam splitter. In the object arm, the light beam formed by the lens 130 penetrates the interior of the examined object and is then backscattered on its internal structures and returns through the lens 130 to the beam splitter. At the same time, the light in the reference arm is reflected against the fixed reference mirror and also returns to the beam splitter, in which the reference beam is generated, then processed by the spectrometer. In the spectrometer the resultant beam is directed to the diffraction grate, which splits the resultant beam into the light spectrum modulated with interference fringes, said spectrum recorded with the detection system. The electric signal generated by the detection system is transmitted to the computation unit 140. The information about the axial structure of the examined object is obtained on the basis of numerical computations in the computation unit 140, for example a PC. The SOCT device 100 communicates with the computation unit via the transmission line, which can also comprise the power supply wires of the SOCT device 100. The image of the examined object's structure can be displayed on the screen 141. The majority of the above-mentioned systems and subassemblies necessary for the operation of the SOCT device are placed inside the SOCT device's casing.

The SOCT device 100, in comparison to typical SOCT devices, is additionally provided with an attachment, that is an additional optical system located between the lens of the SOCT device and the examined object, and in the solution shown in FIG. 1, it is the attachment 150 with the additional optical system 154 fixed to the lens 130 of the SOCT device 100. The attachment 150 shown in FIG. 1 is provided with the cylindrical element 151 mounted on the lens 130 of the SOCT device 100 and the additional optical system 154 placed inside the body or the casing constituting an integral whole with the cylindrical element 151 or connected with the cylindrical element. Moreover, the attachment can be provided with the adjusting system, which enables such positioning of the attachment 150 relative to the lens 130 of the SOCT device 100 that the symmetry axis 153 of the attachment 150 corresponds to the axis of the lens 130 of the SOCT device 100.

FIG. 2 shows the route of the light beam in the object arm of the SOCT device without any additional equipment while scanning the back section of the object. The light beam in the object arm or the object arm of the light beam or, shortly, the object beam 221 goes from the beam splitter 210 through the first system 220 forming the object beam 221, the optical system 230 for the change of the beam's route, where for example at least one mirror is placed on the rotary mechanism, the second system 240 forming the object beam and the third system 250 forming the project beam, and is directed onto the examined object 270. The second system 240 with the focal length f₁ forming the object beam and the third system 250 with the focal length f₂ forming the object beam can constitute the assembly 200 of the optical elements forming the object beam, the route of which depends on the application of the SOCT Device. The object beam 221, after the change of the distribution direction, is focused by the first focus 240, and after it goes through the third optical system 250 it is focused by the second focus 251, which constitutes the external focus of the entire optical system of the lens of the SOCT device. Within the external focus 251 of the entire optical system of the lens, there is the optical element, for example the pupil 260 of the eye 270. Through the pupil with its own focal length, the object beam is directed to the back section of the examined object, for example the fundus 271 of the eye 270. The axis 231 of the object beam 221 in FIG. 2 corresponds to the axis 261 of the pupil 260 and the axis 275 of the eye 270.

FIG. 3 shows the schematic view of the light beam's route while scanning the front section of the object, formed by the assembly of optical elements forming the object beam, comprising the optical system 300 of the lens similar to the assembly 200 of optical elements shown in FIG. 2, and the additional optical assembly 305 of the resultant focal length f₃ of optical elements forming the object beam, which in FIG. 3 is the optical element or the additional optical system 380. The light beam in the object arm, similarly to the solution shown in FIG. 2, goes from the beam splitter through the first system 320 forming the object beam, the optical system 330 for changing the route of the beam, the second system 340 forming the object beam and is focused by the third focus 351. The third focus 351 is the external focus for the entire optical system of the lens of the SOCT device. In the external focus of the entire optical system of the lens, there is the additional optical system 380 which changes the route of the object beam. Thanks to this additional optical system 380 with its own focal length f₃, the object beam is directed to the front section of the object, for example to the external surface 372 of the cornea of the eye 370. While scanning the front section of the object, the internal optical elements of the object, for example the pupil 360 of the eye 370, are not used for forming the object beam.

FIG. 4 shows the side view of one of the variants of the attachment 450, the body of which is provided with the cylindrical element 451 mounted on the lens of the SOCT device. Moreover, the attachment can be provided with the adjusting and/or mounting systems 490, which enable the movement of the attachment 450, and thus make it possible to position the additional optical system 454 properly relative to the lens of the SOCT device. One of the adjusting and/or mounting systems 490 is provided with the flange 495, vertical mounting elements 491, 492 and horizontal mounting elements 493, 494 which prevent movement of the attachment 450 in the vertical plane or along the axis 455 of the attachment 450. The flange 495 can constitute an integral whole with the casing 453 of the additional optical system 454, this whole screwed to the cylindrical element 451. The casing 453 is provided with the internal through hole which from the inside ends with the recess 456, inside which the additional optical system 454 is placed, such as the optical system comprising one or several lenses of the resultant focal length f₃ marked in FIG. 3. Another adjusting and/or mounting system 490 is provided with screws 496, 497 screwed into the cylindrical element 451 mountable on the lens of the SOCT device. The screws 496, 497 make it possible to fix the attachment 450 in position relative to the lens of the SOCT device, and, if necessary, to position the attachment 450 transversally relative to the axis of the lens of the SOCT device through deeper or shallower screwing in the cylindrical element 451. To enable the mounting of the attachment 450 on the lens of the SOCT device, the diameter d₁ of the cylindrical chamber 459 of the attachment 450 is almost equal or slightly larger than the external diameter D of the lens, so that it ensures slideable fitting of the internal hole of the cylindrical chamber 459 of the attachment 450 and the lens of the SOCT device.

In another solution, shown in FIG. 4, the cylindrical element can be provided with a notch 458 over the entire thickness of the jacket of this cylindrical element 451 which enables the mounting of the attachment 450 on the lens of the SOCT device. The diameter d₁ of the cylindrical chamber 459 of the attachment 450 in this solution is smaller than the external diameter D of the lens. While mounting the attachment 450 the notch is increased, which leads to an increase in the diameter d₁, which enables the mounting of the attachment 450 on the lens of the SOCT device.

FIG. 5 shows the side view of another variant of the attachment 550, the body of which is provided with the cylindrical element 551 mountable on the lens of the SOCT device. Moreover, the attachment 550 can be provided with adjusting and/or mounting systems 550 which enable proper transversal and longitudinal positioning of the attachment 550 relative the lens of the SOCT device. One of the adjusting and/or mounting systems 590 is provided with the flange 595, vertical mounting elements 591, 592 and horizontal mounting elements 593, 594 which enable movement of the attachment 550 on the horizontal plane and along the axis 555 of the attachment 550. The flange 595 is provided with the protruding cylindrical pipe 557 with external fine thread 558 and holes for the vertical mounting elements 591, 592 and horizontal mounting elements 593, 594 that enable fixing of the flange 595 to the cylindrical element 551. The body 453 and the cylindrical pipe 557 are provided with the internal through hole, through which the object beam can pass. In case there is no flange in the solution, or any vertical or horizontal mounting elements, the protruding cylindrical pipe 557 with the external fine thread 558 is fixed directly to the cylindrical element 551 or the cylindrical pipe 557 forms an integral whole with the cylindrical element 551. The sleeve 553 is screwed onto the cylindrical element 557, said sleeve having the threaded internal whole on one side, with the thread the contour of which corresponds to the contour of the external thread 558 notched on the cylindrical element 557 of the flange 595. On the other side of the sleeve 553, on its outside, there is the recess 556, inside which the additional optical system 554 is placed, such as the optical system comprising a single lens or several lenses, the first of which has the focal length f₃. It is also possible to have such a solution, that the sleeve is provided with the external thread and is screwed in the cylindrical element, the hole of which is provided with the internal thread. Another adjusting and/or mounting system 590 is provided with the screws 596, 597 screwed in the cylindrical element 551 mounted on the lens of the SOCT device by means of the elastic and deformable cylindrical insert 552 made of elastically deformable material, for example rubber. The screws 596, 597 in this solution constitute a possible additional fixing means for the attachment 450, fixing it in the position relative to the lens of the SOCT device, as the mounting element here is the elastic deformable cylindrical insert 552 placed inside the cylindrical element 551. The external diameter d₂ of the elastic deformable insert 552 is slightly larger than the diameter of the internal cylindrical chamber 459 of the attachment 450, to prevent sliding out of the insert 552 from the attachment 450. At the same time, the internal diameter d₃ is slightly smaller than the external diameter D of the lens, so that it ensures firm mounting of the attachment 550 on the lens of the SOCT device, following elastic deformation of the sleeve 552.

The solution according to the invention has been presented in the form of selected embodiments. However, the examples do not limit the invention. It is obvious that some modifications can be made without changing the material part of the solution. The presented embodiments do not fully exhaust the possibilities of applying the solution according to the invention.

1. The apparatus for examination of objects by means of optical tomography (SOCT device) with an attachment comprising a device generating a light beam, a device splitting the light beam into at least one reference beam and at least one object beam directed through the lens to the examined object, a device generating a resultant beam from at least one reference beam and at least one object beam scattered on the object and returning through the lens, a device for the spectral analysis of the resultant beam and an attachment, characterized in that the attachment is an additional optical system (154, 380, 454, 554) located between the lens of the SOCT device (300) and the examined object (370).

2. The apparatus according to claim 1 characterized in that the lens of the SOCT device is provided with the external focus for focusing the object beam, in which, for the period of examining the object from the outside, the lens (380) of the additional optical system is placed, said device comprising more than a single lens.

3. The apparatus according to claim 1 characterized in that the lens of the SOCT device is provided with the external focus (251) focusing the object beam, in which, for the period of examining the back section of the object, the area of the pupil (260) is located.

4. The apparatus according to claim 1, characterized in that the additional optical system (154, 454, 554) is placed inside the attachment (150, 450, 550) mounted on the lens (130) of the SOCT device (100).

5. The apparatus according to claim 1 characterized in that the additional optical system (154, 454, 554) is placed in the attachment (150, 450, 550) mounted on the lens (130) of the SOCT device (100) comprising the cylindrical element (151, 451, 551) mounted on the lens of the SOCT device (100) located opposite the attachment (150, 450, 550) relative to the additional optical system (154, 454, 554).

6. The apparatus according to claim 4 characterized in that the attachment is provided with at least one adjusting and/or mounting system (490) that enables movement of the additional optical system (454) relative to the lens of the SOCT device.

7. The apparatus according to claim 6 characterized in that the adjusting an/or mounting system (490) is provided with the flange (495) connecting the cylindrical element (451) and the casing (456), inside which the additional optical system (454) and at least one vertical mounting element (491, 492) and/or horizontal mounting element (493, 494) are placed, which prevent movement of the additional optical system (454) on the vertical plane and/or along the axis (455) of the attachment (450).

8. The apparatus according to claim 6 characterized in that the adjusting and/or mounting system (490) is provided with at least one screw (496, 497) screwed in the cylindrical element (451), which in contact with the lens enables movement of the additional optical system (454) on the plane perpendicular to the axis of the attachment (450).

9. The apparatus according to claim 4 characterized in that the cylindrical element (551) is provided with the threaded pipe (557) connecting the casing in the form of the sleeve (556), inside which the additional optical system (554) is placed.

10. The apparatus according to claim 4 characterized in that the cylindrical element is provided with the threaded hole connecting the casing in the form of the sleeve with the external thread, inside which the additional optical system (554) is placed.

11. The apparatus according to claim 1 characterized in that the additional optical system (154, 454, 554) is a single lens or an assembly of lenses or a single lens from the assembly of lenses with different focal lengths.

12. The apparatus according to claim 4 characterized in that inside the cylindrical element (551) there is an elastic deformable cylindrical insert (552).

13. The apparatus according to claim 4 characterized in that the cylindrical element (451) is provided with the notch (458) over the entire thickness of the jacket of the cylindrical element (451).

14. The attachment for the apparatus for examination of objects by means of optical tomography (SOCT device) characterized in that it has the form of the attachment (150, 450, 550) mountable on the lens of the SOCT device, comprising the cylindrical element (151, 451, 551) mountable on the lens of the SOCT device and the additional optical system (154, 454, 554) located opposite the attachment relative to the cylindrical element.

15. The attachment according to claim 14 characterized in that the attachment is provided with at least one adjusting and/or mounting system (490) enabling movement of the additional optical system (454) relative to the lens of the SOCT device.

16. The attachment according to claim 14 characterized in that the cylindrical element (551) is provided with the threaded pipe (557) connecting the casing in the form of the sleeve (556), inside which the additional optical system (554) is placed.

17. The attachment according to claim 14 characterized in that inside the cylindrical element (551) there is the elastic deformable cylindrical insert (552).

18. The attachment according to claim 14 characterized in that the cylindrical element (451) is provided with the notch (458) over the entire thickness of the jacket of the cylindrical element (451).

19. The method for examination of object by means of the apparatus for examination of objects using optical tomography (SOCT device) with the attachment comprising the device generating the light beam, the device splitting the light beam into at least one reference beam and at least one object beam directed through the lens to the examined object, the device generating the resultant beam from at least one reference beam and at least one object beam scattered by the object and returning from the object through the lens, the device for spectral analysis of the resultant beam and the attachment, characterized in that for the period of examining the object from the outside by means of the SOCT device, the attachment is mounted on the SOCT device, and the lens of the additional optical system of this attachment or the first lens of the additional optical system comprising more than a single lens is placed in the external focus of the focus of the SOCT device, and for the period of examining the back section of the object the attachment is removed from the lens of the SOCT device.
